(19) United States
(12) Patent Application Publication
(10) Pub. No.: US 2005/0230028 A1
(43) Pub. Date: Oct. 20, 2005

(54) Ceramic plates and production method thereof

(75) Inventors: Akio Iwase, Nishio-city (JP); Toshio Ooshima, Oobu-city (JP); Tetsuji Itou, Kariya-city (JP); Shige Kadotani, Chita-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/098,457

(22) Filed: Apr. 5, 2005

(30) Foreign Application Priority Data
Apr. 14, 2004 (JP) 2004-119419
Dec. 28, 2004 (JP) 2004-379800

(51) Int. Cl. C03B 29/00

(52) U.S. Cl. 156/89.11; 156/89.12

(57) ABSTRACT

A method for producing thin sheet-like ceramic plates comprising the steps of: forming a green sheet from a ceramic raw material; arranging a separation material comprising a burning loss material capable of being burnt and lost by baking, in a punch-out area for punching out sheet pieces on a surface of the green sheet; punching out the punch-out area from the green sheet to obtain the sheet pieces; stacking the punched out sheet pieces to form an intermediate stacked body; baking the intermediate stacked body to obtain a baked stacked body comprising ceramic layers stacked one upon another; and separating the ceramic layers from the baked stacked body to obtain discrete ceramic sheets, and thin sheet-like ceramic plates produced using this production method.

### BACKGROUND OF THE INVENTION

1. Field of the Invention

This invention relates to a thin sheet-like ceramic plate and its production method.

2. Description of Related Art

Hitherto, sheet-like ceramic plates having a small thickness have been produced, in accordance with conventional methods, by baking a ceramic sheet made of a ceramic raw material (see, Japanese Unexamined Patent Publication (Kokai) No. 10-218672, for example).

However, the conventional production method of the ceramic plate described above and the ceramic plate obtained by this method involve the following problems. Namely, warp and surface waving are likely to occur in the resulting ceramic plate during baking the sheet pieces and thus the flatness of the plate sometimes cannot be secured. Therefore, this production method cannot easily produce thin ceramic plates having a large surface area.

### SUMMARY OF THE INVENTION

This invention is intended to solve the problems described above, and is aimed at providing a method capable of efficiently producing a thin sheet-like ceramic plate, and the ceramic plate having high flatness that is obtained by the production method.

In the first aspect thereof, this invention resides in a method for producing thin sheet-like ceramic plates by baking a ceramic raw material, which comprises the steps of: forming a green sheet from a ceramic raw material; arranging a separation material comprising a burning loss material capable of being burnt and lost by baking, in a punch-out area for punching out sheet pieces on a surface of the green sheet; punching out the punch-out area from the green sheet to obtain the sheet pieces; stacking the punched out sheet pieces to form an intermediate stacked body; baking the intermediate stacked body to obtain a baked stacked body comprising ceramic layers stacked one upon another; and separating each of the ceramic layers constituting the baked stacked body to obtain discrete ceramic plates.

In the separation material arrangement step in the production method of the ceramic plates according to the first invention, the separation material, comprising the burning loss material that is burnt and lost by baking, is arranged in the punch-out area on the surface of the green sheet. The intermediate stacked body comprising the stacked sheet pieces is formed in the punch-out step and the stacking step. The intermediate stacked body is then baked in the baking step to obtain the baked stacked body having the ceramic layers stacked on upon another.

As described above, when the sheet pieces are stacked as the intermediate stacked body and the baked stacked body is formed by subsequent baking, warp and other defects are not produced in each of the stacked sheet piece and thus each ceramic layer having a high flatness can be obtained. This is because each ceramic layer under the stacked state is restricted by other stacked ceramic layers, and warp and other defects cannot develop independently of other stacked ceramic layers.

Further, in the baked stacked body described above, the burning loss material in the separation material stacked and inserted between the sheet pieces stacked adjacent to each other is burnt and lost during baking. Therefore, in the separation step described above, each ceramic layer constituting the baked stacked body can be separated relatively easily to thereby obtain the separated ceramic plates described above. The ceramic plates obtained by separating the baked stacked body thus have excellent quality and are substantially free from warp and waving of the surface and other defects.

In addition, when the baked stacked body is produced by baking the intermediate stacked body having a large number of stacked sheet pieces as in the first invention, a large number of ceramic layers capable of being converted to the ceramic plates can be simultaneously baked in the baked staked body. Thus, a large number of ceramic plates can be efficiently produced at one time by subsequently carrying out the separation step described above.

As described above, using the production method of the ceramic plates according to the first invention, it becomes possible to produce, extremely efficiently, thin sheet-like ceramic plates having high flatness and excellent quality.

In the second aspect thereof, this invention resides in a ceramic plate produced by utilizing the production method of ceramic plate according to the first invention. Therefore, the ceramic plate according to the second invention hardly has any warp and waving of the surface, and thus has excellent quality.

### BRIEF DESCRIPTION OF THE DRAWINGS

FIG. 1 is a perspective view showing a green sheet for punching out sheet pieces in Example 1;

FIG. 2 is a sectional view showing a construction of a punch-out/stacking apparatus in Example 1;

FIG. 3 is a sectional view showing the mode at the instant of punching out the sheet piece by a Thomson blade in Example 1;

FIG. 4 is an enlarged sectional view showing a sectional structure of a tip of a Thomson mold in Example 1;

FIG. 5 is a perspective view showing a mode of forming an intermediate stacked body by stacking the sheet pieces in Example 1;

FIG. 6 is a perspective view showing the intermediate stacked body in Example 1;

FIG. 7 is an enlarged sectional view showing a periphery of a separation material layer in the intermediate stacked body in Example 1;

FIG. 8 is a perspective view showing a baked stacked body in Example 1;

FIG. 9 is a perspective view showing a ultrasonic vibration apparatus in Example 1;

FIG. 10 is a perspective view showing the mode of formation of another intermediate stacked body in Example 1;

FIG. 11 is a perspective view showing another intermediate stacked body in Example 1;

FIG. 12 is a perspective view showing a green sheet from which sheet pieces are punched out in Example 2;

FIG. 13 is a perspective view showing the mode of formation of an intermediate stacked body by stacking the sheet pieces in Example 2;

FIG. 14 is a perspective view showing the intermediate stacked body in Example 2;

FIG. 15 is a perspective view showing the mode of formation of another intermediate stacked body in Example 2;

FIG. 16 is a perspective view showing another intermediate stacked body in Example 2;

FIG. 17 is an enlarged sectional view showing a periphery of a separation material layer in an intermediate stacked body in Example 3;

FIG. 18 is an enlarged sectional view showing an inter-layer structure between ceramic layers in a baked stacked body in Example 3; and

FIG. 19 is a sectional view showing a construction of a punch-out/stacking apparatus in Example 4.

### DESCRIPTION OF THE PREFERRED EMBODIMENTS

In the first invention described above, two or more miniature blocks (hereinafter referred to as “mini-blocks”) consisting of the separation material described above are preferably arranged, while forming a gap between the adjacent mini-blocks, in the punch-out area in the separation material arrangement step. According to this embodiment, as the plurality of mini-blocks has small variance of the film thickness, it becomes possible to obtain high accuracy in the film thickness. In other words, when the separation material is arranged as a plurality of mini-blocks, control of the film thickness becomes easier than when the separation material is deposited on the entire surface of the punch-out area, and uniformity of the film thickness can be improved. Consequently, stacking accuracy of the sheet pieces can be improved and thus the resulting ceramic plate can exhibit high flatness and excellent quality.

Further, because the gaps are disposed among the adjacent mini-blocks, each ceramic layer can be separated more easily in the separation step described above when it is to be separated from the baked stacked body.

When a degreasing step is carried out before the baking step, the degreasing step can be carried out efficiently because of the presence of the gaps. Here, the term “degreasing step” means the step of gasifying a binder of a resin and others contained in the green sheet by heating, and removing them. In other words, the gasified binder can be efficiently and more reliably discharged outside through the gaps. Therefore, production efficiency and quality of the ceramic plates can be improved.

The plurality of mini-blocks are preferably arranged in regular order. According to this embodiment, quality and production efficiency of the ceramic plates can be further improved.

More preferably, each of the plurality of mini-blocks has the same shape and the same surface area. According to this embodiment, the effects described above can be further improved.

Incidentally, the mini-blocks may be arranged at random or the shape and the surface area may be varied, whenever necessary.

The ceramic material described above comprises at least any one of PZT (lead zirco-titanate; Pb(Zr,Ti)O₃), PLZT (lead lanthanum zircn-titanate; (Pb, La)(Zr, Ti)O₃), BaTiO₃, Al₂O₃, AlN, TiO₂, ZrO₂ and ZnO. According to this embodiment, as the ceramic plate formed of the ceramic raw material described above is likely to undergo warp during the baking step, the function and the effect of the first invention become particularly effective.

Further, it is preferred that the separation material consists of only the burning loss material. According to this embodiment, because the separation material consisting only of the burning loss material is burnt and lost almost completely from between the ceramic layers obtained by baking, the baked stacked body can be easily separated to obtain the ceramic plate described above.

Furthermore, it is preferred that the separation material described above comprises the burning loss material dispersed in the ceramic raw material. According to this embodiment, when the separation material having the burning loss material dispersed in the ceramic raw material is used, the baked stacked body in which porous layers of the ceramic material are formed between the ceramic layers can be formed by baking. In other words, the baked stacked body has the construction in which the ceramic layers stacked adjacent to one another are bonded through the porous layers that are porous and brittle. Consequently, the baked stacked body secures a predetermined strength and thus its handling becomes easy.

It is also preferred that 100 wt % of the separation material contains 10 to 50 wt % of the burning loss material.

When the content ratio of the burning loss material in the separation material is adjusted to that within the range described above, the strength of the baked stacked body can be kept at a suitable level and both easy handling of the baked stacked body and ease of separation into the ceramic plates can be satisfied.

The burning loss material preferably contains at least either one of carbon particles and organic carbide particles.

According to this embodiment, the baked stacked body can be obtained by the baking step and, at the same time, the burning loss material can be suitably removed upon burning. That is, as all of the carbon particles or the organic carbide particles, other binder, dispersant, plasticizer, solvent, oil and others contained in the separation material have burning loss temperatures or evaporation temperatures that are lower than an initial baking temperature of the ceramic raw material constituting the sheet pieces, the separation material is generally burnt or evaporated before start of the baking of the ceramic raw material. However, when the amount of oxygen is made a little insufficient in the initial stage of baking, the carbon particles or the organic carbide particles in the separation material remain and the gaps between the particles of the intermediate stacked body can be kept while the shape of the intermediate stacked body is kept. Consequently, a baked stacked body can be obtained having high dimensional accuracy.

Incidentally, the organic carbide particles are those prepared by carbonizing resin particles or powdery organic particles. Therefore, when the burning loss material is constituted by the organic carbide particles, the burning loss material can be supplied at a low cost and the production cost of the ceramic plate can be suppressed.

In the separation step described above, ultrasonic vibration is preferably applied to the baked stacked body to separate each of the ceramic layers.

In this embodiment, ultrasonic vibration can destroy the bonding structure between the adjacent stacked ceramic layers in the baked stacked layer to thereby obtain the ceramic plates having excellent quality. Incidentally, besides the method for obtaining the ceramic plate by utilizing the ultrasonic vibration, the ceramic plate can be obtained by utilizing a water jet, a vibrator, shot blasting, and so forth.

In addition, it is preferred that the ceramic plate has a thickness of 30 to 250 μm and a surface area of 9 to 900 mm². In this embodiment, as the ceramic plate has a small thickness and thus warp and others are likely to occur, the production method of the ceramic plate according to the first invention can be particularly effectively carried out.

Moreover, it is preferred in the baking step described above that the intermediate stacked body is baked while a load in a stacking direction is applied to the stacked body.

In this embodiment, as the sheet pieces stacked as the intermediate stacked body is baked while keeping the flatness at a high level, the baked and stacked body comprising the stacked ceramic layers having high flatness can be obtained. Using this baked and stacked body, the flatness of the ceramic plate can be further improved.

In the second invention, it is preferred that the ceramic plate has a thickness of 30 to 250 μm and a surface area of 9 to 900 mm².

In this embodiment, a small-sized and high performance electronic components, for example, can be realized by utilizing a ceramic plate having a small thickness and a large surface area.

### EXAMPLES

This invention will be further described with reference to the examples thereof. However, this invention should not be restricted to these examples.

### Example 1

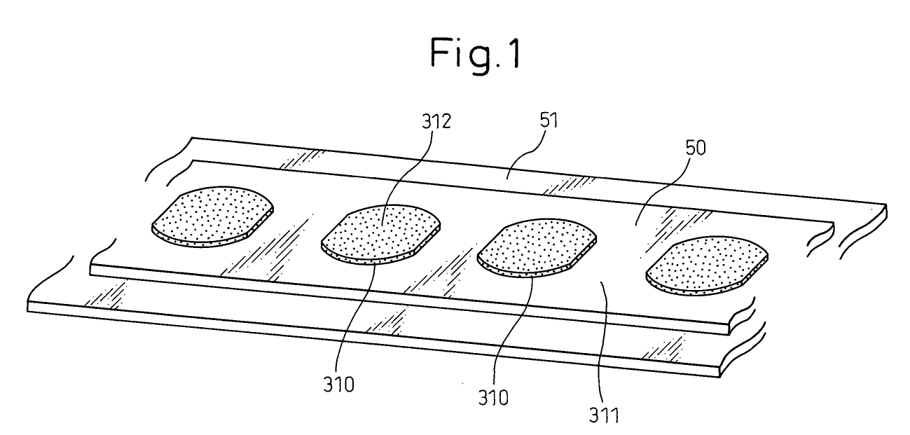

This example is intended to explain a method for producing a ceramic plate 1 and the ceramic plate 1 obtained by this production method. This example will be explained with reference to FIGS. 1 to 11.

This example relates to a production method of a thin sheet-like ceramic plate 1 including the step of baking a ceramic raw material 311.

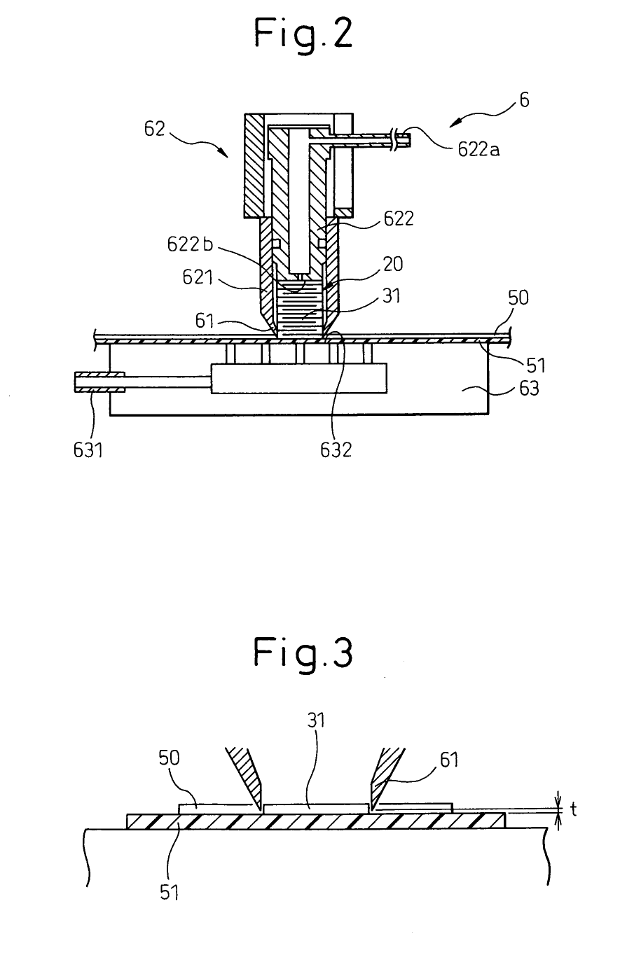

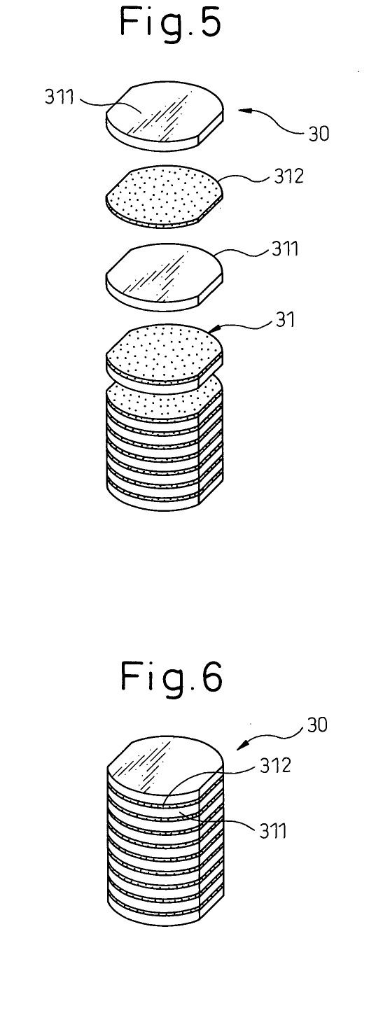

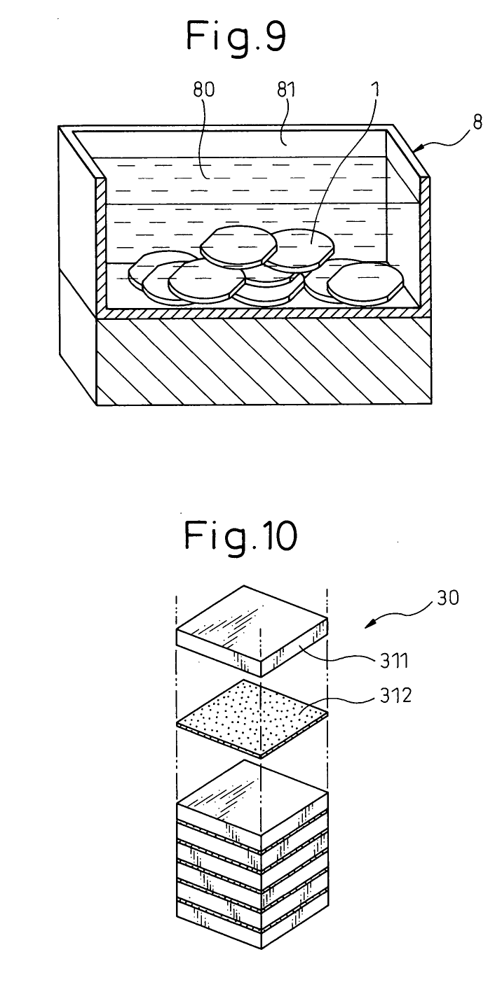

The production method of the ceramic plate 1 of this example includes a green sheet formation step (FIG. 1) of forming a green sheet 50 made of a ceramic raw material 311; a separation material arrangement step (FIG. 1) of arranging a separation material 312 containing a burning loss material capable of being burnt and lost by baking, in a punch-out area 310 for punching out sheet pieces 31 on a surface of the green sheet 50; a punch-out step (FIG. 2) of punching out the punch-out area 310 from the green sheet 50 and obtaining the sheet pieces 31; a stacking step (FIG. 5) of stacking the sheet pieces 31 and forming an intermediate stacked body 30; a baking step (FIG. 8) of baking the intermediate stacked body 30 and obtaining a baked and stacked body 10 having ceramic layers 11 stacked one upon another; and a separation step (FIG. 9) of separating each of the ceramic layers 11 constituting the baked stacked body 10 and obtaining the ceramic plates 1.

The production method will be hereinafter explained in detail.

First, the ceramic plate 1 (FIG. 9) to be produced by this example has a barrel-like shape having a surface area of 52 mm² (diameter 8.5 mm) and a thickness of 80 μm and made of a ceramic material. Besides the barrel shape, the production method of the ceramic plate 1 according to this example can produce the ceramic plates 1 of various shapes such as a circle, a rectangle and a polygon. In other words, the ceramic plate 1 having different shapes can be produced, if the sectional shape of the intermediate stacked body 30 is set to the shape of the ceramic plate 1 to be produced.

Further, according to the production method of the ceramic plate 1 of this example, it is possible to produce highly efficiently and highly accurately the ceramic plate 1 having a surface area of 9 to 900 mm² (diameter of 3 to 30 mm in the case of the circle plate) and a thickness of 30 to 250 μm.

In the production method of the ceramic plate 1 according to this example, the green sheet formation step is first carried out. In this step, the green sheet 50 (FIG. 1) is formed by extending a slurry of the piezoelectric material into a sheet form. Here, the slurry is prepared by adding a binder and trace amounts of a plasticizer and a de-foaming agent into the ceramic raw material 311 as the piezoelectric ceramic such as lead zirco-titanate (PZT) and dispersing them in an organic solvent.

In the green sheet formation step of this example, the slurry is applied onto a carrier film 51 (FIG. 1) by a doctor blade method to form a green sheet 50 having a thickness of 100 μm. Extrusion molding, and other methods, can be employed for forming the green sheet 50 from the slurry, besides the doctor blade method of this example.

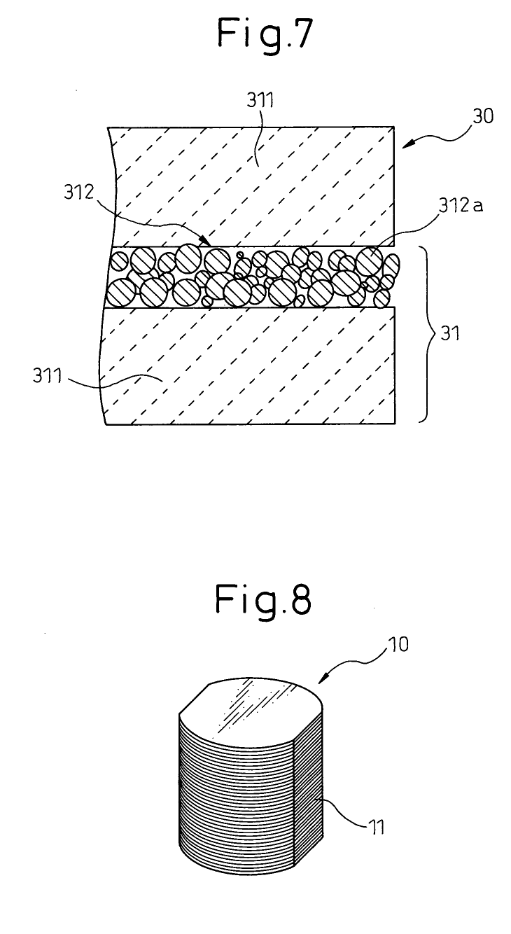

Next, in the separation material arrangement step, the separation material 312 containing the burning loss material capable of being burnt and lost in subsequent baking is applied by screen printing in the punch-out area 310 of the green sheet 50. Note in this example that a material containing carbon particles 312a (FIG. 7) having less thermal deformation and capable of keeping dimensional accuracy of the baked stacked layer 10 at a high level was used as the burning loss material, and the separation material 312 was constituted from only this burning loss material.

Here, the production method of the separation material 312 in this example will be explained. In this example, PVB (product of Denki Kagaku K. K.) is mixed with terpineol as the plasticizer and the mixture is stirred for 2 minutes with a stirrer/de-foaming machine. The mixture is thereafter left standing until the PVB is completely dissolved. After carbon powder and SPAN85 (product of Wako Junyaku K.K.) as a dispersant are added, the mixture is again stirred for 1 minute to give the separation material 312.

Alternatively, powdery organic carbide particles that are carbonized products can be used in place of the separation material 312 consisting of the burning loss material containing the carbon particles 312a in this example. The organic carbide particles can be obtained by carbonizing powdery organic particles or by pulverizing carbonized organic materials. It is possible to use polymer materials such as resins, corn, soy bean and flour as the organic materials, and thus the production cost can be lowered. The ceramic plate 1 of this example can be advantageously produced by using the natural materials that are “frendly” to the environment particularly corn, soy beans, flour and others.

Next, as is illustrated in FIG. 2, punch-out and stacking of the sheet pieces 31 are simultaneously carried out by using a punch-out/stacking apparatus 6 capable of simultaneously conducting the punch-out step and the stacking step. Here, the sheet pieces 31 are punched out from the green sheet 50 and are serially stacked to give the intermediate stacked body 30 (FIGS. 5 and 6) as shown in FIG. 2.

Here, the construction of the punch-out/stacking apparatus 6 in this example and its operation will be explained. As illustrated in FIG. 2, the apparatus is constituted as to be capable of conducting punching-out and stacking in parallel with one another. The punch-out/stacking apparatus 6 has a Thomson blade 61 for punching out the sheet pieces 31 from the green sheet 50, a Thomson mold 62 for accommodating therein the sheet-like stacked body (hereinafter, sheet stacked body) 20 consisting of the stacked sheet pieces 31 and a table 63 for putting a carrier film 51 for holding the green sheet 50.

The Thomson mold 62 in this example has a cylinder portion 621 having substantially a cylindrical shape having the Thomson blade 61 at the distal end thereof on the side of the table 63 and a stacking weight 622 so constituted as to move back and forth in accordance with the stacking height of the sheet stacked body 20 stacked inside the cylinder portion 621.

The stacking weight 622 has a suction port 622a for connecting a tube extended from a vacuum pump (not shown) as shown in FIG. 2. A suction port communicating with the suction port 622a opens on a stacking adsorption surface 622b exposed inside the cylinder portion 621 on the outer surface of the stacking weight 622. The Thomson mold 62 is so constituted as to adsorb the stacking end face of the sheet stacked body 20 to the stacking adsorption surface 622b and to hold the sheet stacked body inside the cylinder portion 621.

The table 63 is constituted in such a fashion as to place and hold thereon the carrier film 51 holding the green sheet 50. The punch-out/stacking apparatus 6 of this example feeds the carrier film 51 put on the table 63 by a feed mechanism, not shown, and serially punches out the sheet pieces 31. The table 63 in this example has a suction port 631 connected to the vacuum pump, not shown. The table 63 has an adsorption port communicating with the suction port 631 on its placement surface 632 and adsorbs and holds the carrier film 51 put thereon.

Furthermore, as shown in FIG. 3, the punch-out/stacking apparatus 6 is constituted in such a fashion that when the Thomson mold 62 moves and comes closest to the table 63, the tip of the Thomson blade 61 and the surface of the carrier film 51 keep a slight clearance (t) corresponding to 5 to 10% of the thickness of the green sheet 50. Consequently, the punch-out/stacking apparatus 6 can reliably punch out only the sheet pieces 31 by its Thomson blade 61 from the green sheet 50 held by the carrier film 51.

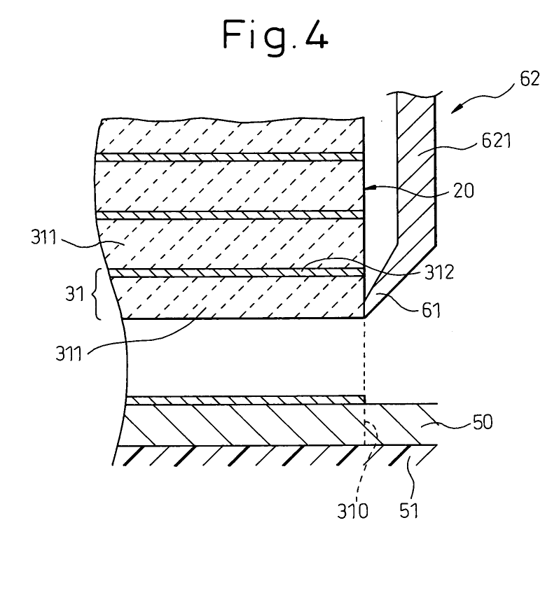

Here, the Thomson mold 62 in this example has the cylinder portion 621 having an inner diameter greater than the sheet stacked body 20 to be molded as shown in FIG. 4. The Thomson mold 62 has the Thomson blade 61 the diameter of which reduces as it comes closer to the table 63, and the tip of the Thomson blade 61 is substantially coincident with the outer edge shape of the punch-out area 310.

Therefore, in the punch-out/stacking apparatus 6 in this example, friction does not occur between the inner peripheral surface of the cylinder portion 621 and the outer peripheral surface of the sheet stacked body 20 when the sheet stacked body 20 is formed inside the cylinder portion 621. In other words, deformation, or other defects, do not occur at the outer peripheral portion of the stacked sheet pieces 31.

Therefore, according to the punch-out/stacking apparatus 6, the intermediate stacked body 30 can be produced while the stacked sheet pieces 31 have high flatness.

When the intermediate stacked body 30 is produced by using the punch-out/stacking apparatus 6 having the construction described above, the carrier film 51 holding the green sheet 50 is put on the placement surface 632 of the table 63 as shown in FIG. 2. The carrier film 51 is then moved forth in the longitudinal direction to bring the punch-out position by the Thomson blade 61 into conformity with the punch-out area 310 (FIG. 1) and to punch out the sheet pieces 31. Punching of the sheet pieces 31 is continuously carried out and the sheet stacked body 20 is serially formed inside the cylinder portion 621 of the Thomson mold 62. In this example, the procedure described above is repeated a predetermined number of times, and the intermediate stacked body 30 having a predetermined stacking number of sheet pieces 31 is produced.

The intermediate stacked body 30 having the construction in which the separation material layer 312 is stacked between the adjacent layers of the ceramic raw material 311 can be obtained by stacking the sheet pieces 31 as shown in FIGS. 5 and 6. Incidentally, FIG. 7 is an enlarged sectional view showing in magnification the portion around the separation material layer 312. As shown in this drawing, the mean particle diameter of the carbon particles 312a constituting the separation material is set to 6 μm whereas the mean particle diameter of the PZT particles constituting the ceramic raw material 311 is set to 0.5 μm.

Next, as shown in FIG. 8, the intermediate stacked body 30 described above is baked in the baking step to obtain the baked stacked body 10. The baking step of this example is carried out inside a not-shown baking furnace.

First, the degreasing step is carried out at a furnace inner temperature of 80 to 450° C. for 95 hours. The binder contained in the sheet pieces 31 is gasified and removed by heating. The baking step is then carried out at 450 to 1,100° C. for 15 hours and the baking furnace is gradually cooled in the course of 15 hours to bake the intermediate stacked body 30. Incidentally, baking is carried out in the baking step of this example under the state where a predetermined magnitude of load is allowed to act on the intermediate stacked body 30 in its stacking direction.

The baked stacked body 10 can be obtained by baking the intermediate stacked body 30 while the shape of each sheet piece 31 stacked with high flatness is kept at a high level of accuracy by controlling the furnace inner temperature of the baking furnace as described above. In this baked stacked body 10, the burning loss material constituting the separation material 312 is burnt and lost during the baking process in which the ceramic raw material 311 constituting the sheet pieces 31 is baked.

At this time, oxygen necessary for burning the carbon particles 312a tends to become insufficient in the separation material layer 312. Therefore, the carbon particles 312a in the separation material layer 312 are burnt in a temperature range higher than the original burning temperature.

In the baking step described above, therefore, the possibility is small that all the separation material 312 is completely burnt before the ceramic raw material 311 starts baking. For this reason, baking can be carried out while the shape of the intermediate stacked body 30 is maintained, and the baked stacked body 10 having high dimensional accuracy can be obtained.

Thereafter, as shown in FIG. 9, the separation step of this example is carried out by using a ultrasonic wave vibration machine 8 having an accommodation tank 81 for accommodating the baked stacked body 10 and a ultrasonic vibration plate (not shown) bonded to the back of the bottom surface of the accommodation tank 81. In this step, the baked stacked body 10 (FIG. 8) is accommodated in the accommodation tank 81 filled with water 80 as a fluid and the ultrasonic wave vibration plate is allowed to vibrate. Consequently, the inter-layer structure between the adjacent ceramic layers 11 of the baked stacked body 10 can be destroyed and the baked stacked body 10 can be separated into a large number of ceramic plates 1.

As described above, in the production method of the ceramic plate 1 of this example, after the separation material arrangement step of arranging the separation material comprising the burning loss material capable of being burnt and lost by baking on the surface of the punch-out area 310 of the surface of the green sheet 50 is carried out, the punch-out step and the stacking step are carried out to form the intermediate stacked body 30 having the sheet pieces 31 stacked one upon another. The intermediate stacked body 30 is then baked in the subsequent baking step to obtain the baked stacked body 10 having the stacked ceramic layers 11.

As described above, the intermediate stacked body 30 is first formed by stacking the sheet pieces 31 one upon another and is then baked to form the baked stacked body 10. In this way, baking can be carried out without inviting warp and other defects of each sheet piece 31. This is because the possibility is extremely small that warp and other defects occur in each ceramic layer 11 independently of other stacked ceramic layers 11 under the stacked state. Accordingly, each ceramic layer 11 having high flatness can be obtained in the baked stacked body 10.

In this baked stacked body 10, the burning loss material in the separation material 312 stacked between the adjacent ceramic layers 11 is burnt and lost. Therefore, each ceramic layer 11 constituting the baked stacked body 10 can be separated relatively easily in the separation step to obtain the ceramic plate 1. In addition, the ceramic plate 1 obtained by separating the baked stacked body 10 is almost free from warp and waving of the surface and has high quality.

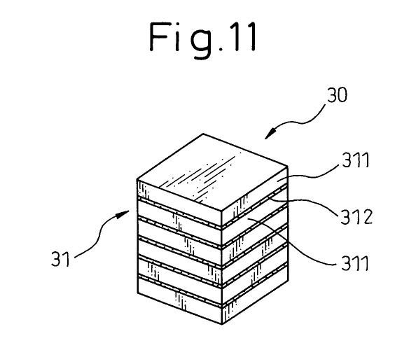

A ceramic plate having substantially a square shape can be produced in place of the ceramic plate 1 having the barrel shape in this example. To obtain the ceramic plate having the square shape, an intermediate stacked body 30 is produced by stacking the sheet pieces 31 punched out into a substantially square shape and is then baked to form a baked stacked body 10 and each ceramic layer 11 is separated from the resulting baked stacked body 10 as shown in FIGS. 10 and 11.

### Example 2

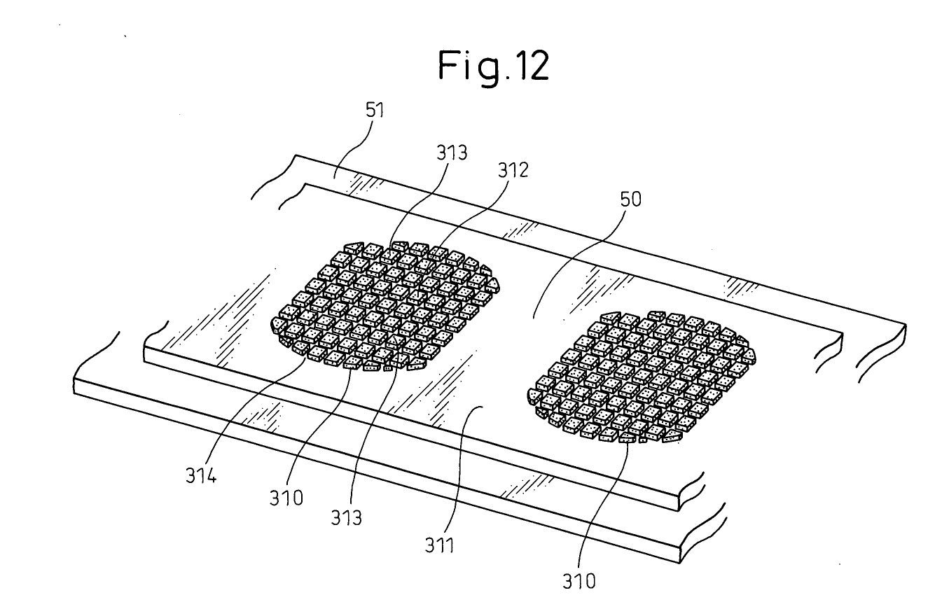

This example is intended to explain a method where a plurality of mini-blocks 313 of the separation material 312 is arranged with gaps 314 among them in the punch-out area 310 in the separation material arrangement step of Example 1, as shown in FIG. 12. This example will be explained with reference to FIGS. 12 to 16.

In this example, a plurality of mini-blocks 313 made of the separation material 312 containing the burning loss material is arranged by screen printing with the gaps 314 among them in the punch-out area 310 of the green sheet 50 in the separation material arrangement step as shown in FIG. 12. The mini-blocks 312 are arranged in a grid form in regular order. Each mini-block 312 has a square shape and has the same surface area. Mini-block 312 each has a surface area of 0.16 mm² in this example.

The separation material 31 is solely composed of the burning loss material as in Example 1.

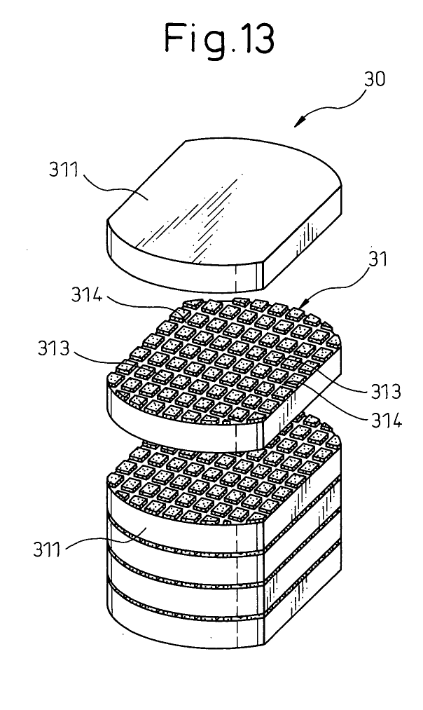

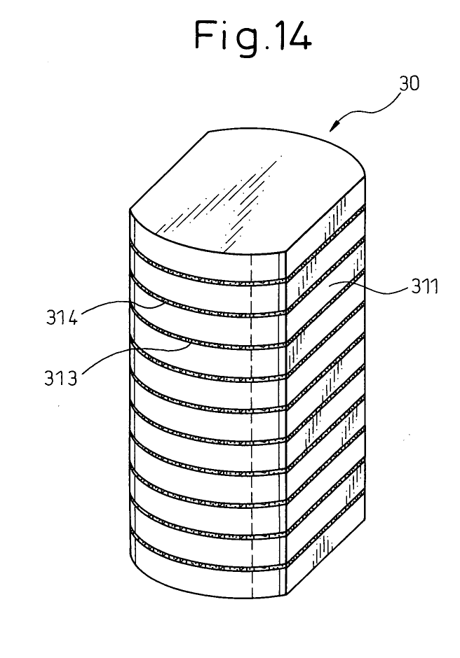

After the separation material arrangement step, the sheet pieces 31 obtained by punching out the punch-out area 50 by using the punch-out/stacking apparatus 6 are serially stacked as shown in FIG. 13. A predetermined number of sheet pieces 31 are stacked to produce the intermediate stacked body 30 as shown in FIG. 14.

Other conditions are the same as those of Example 1.

In this example, as a plurality of mini-blocks 313 arranged in the punch-out area 310 have small variance of thickness, it becomes possible to acquire high thickness accuracy. Therefore, stacking accuracy of the sheet pieces 31 can be improved and thus the resulting ceramic plate 1 has higher flatness and excellent quality.

Further, because the gaps 314 are disposed between the adjacent mini-blocks 313, the binder gasified by heating in the degreasing step can be efficiently discharged outside from the gaps 314 and can be more reliably removed. In the separation step, further, the adjacent ceramic layers 11 of the baked stacked body 10 can be separated further easily. Accordingly, the quality and the production efficiency of the ceramic plate 1 can be improved.

It is also possible to obtain other functions and effects which are similar to those of Example 1.

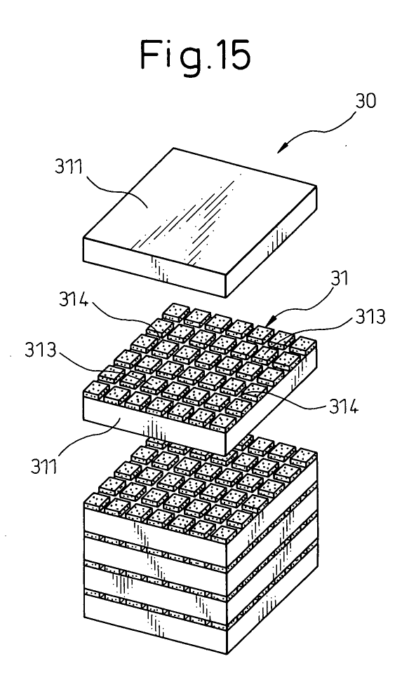

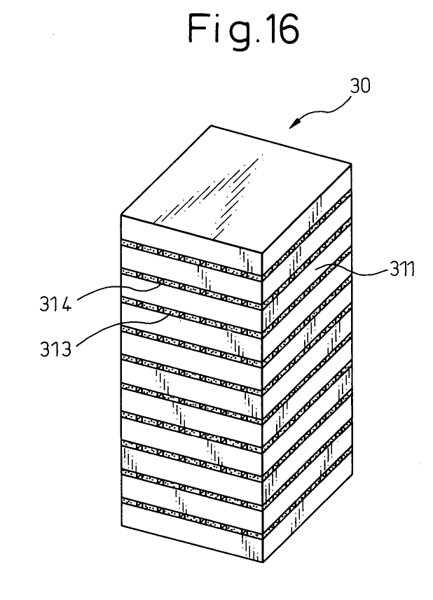

A ceramic sheet having substantially a square shape can be produced in place of the ceramic sheet 1 having the barrel shape in this example. To obtain the ceramic sheet having the square shape, an intermediate stacked body 30 is produced by stacking the sheet pieces 31 punched out into a substantially square shape and is then baked to form the baked stacked body 10 and each ceramic layer 11 is separated from the resulting baked stacked body 10 as shown in FIGS. 15 and 16.

Incidentally, the arrangement of the mini-blocks 313 and their shape and area can be changed in various ways.

### Example 3

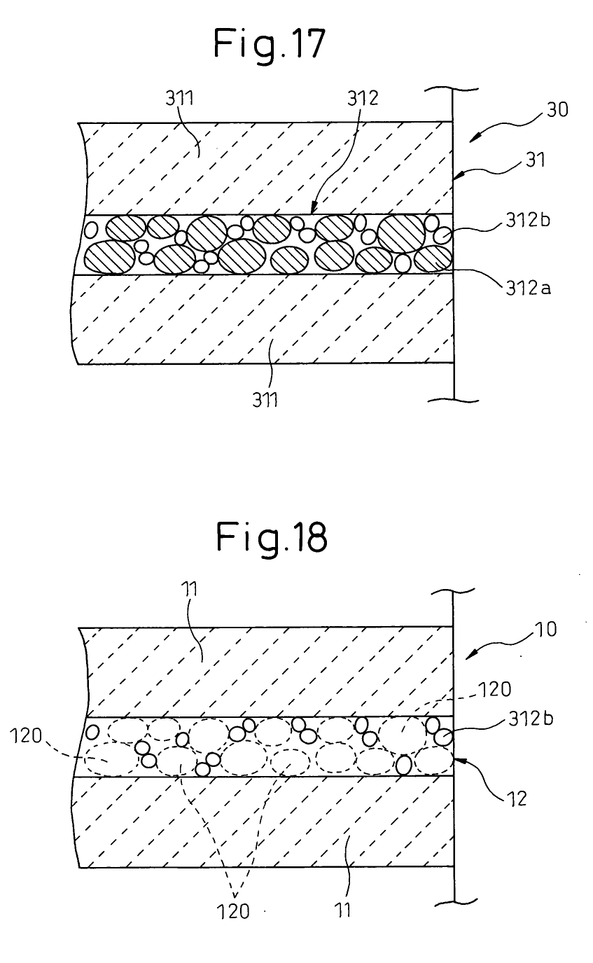

This example is intended to explain a method where the composition of the separation material 312 is changed, while the method is carried out on the basis of Example 1. This example will be explained with reference to FIGS. 17 and 18.

In this example, the separation material 312 prepared by dispersing the carbon particles 312a as the burning loss material in the slurry of the ceramic raw material 311 is used in place of the separation material consisting solely of the burning loss material as shown in FIG. 17. Note that FIG. 17 shows the enlarged sectional structure of the portion in the periphery of the layer in which the separation material 312 is arranged in the intermediate stacked body 30.

In this example, carbon particles having a mean particle diameter of 6 μm are used as the burning loss material. This mean particle diameter is about 12 times the mean particle diameter (0.5 μm) of the piezoelectric particles 312b forming the slurry. The slurry and the burning loss material are mixed so that about 38 wt % of the burning loss material is contained in 100 wt % of the separation material 312.

In the baked stacked body 10 obtained by baking the intermediate stacked material 30 containing the arrangement layer of the separation material 312, a large number of burning loss apertures 120 formed by burning of the carbon particles 312a are formed between the layers of the adjacent ceramic layers 11, and a brittle porous layer 12 of the ceramic material is formed. The stacking strength of the baked stacked body 10 can be improved and its handling becomes easy when the inter-layer structure of the ceramic layer 11 is formed by this porous layer 12.

Other conditions, functions and effects are similar to those of Example 1.

In this example, it is preferred that the mean particle diameter of the carbon particles 312a, for example, constituting the burning loss material is within the scope of from 2 to 20 times the mean particle diameter of the piezoelectric particles 312b. When the mean particle diameter of the carbon particles 312a constituting the burning loss material falls within this range, the burning loss apertures 120 having a suitable size can be formed in the ceramic material, and both stacking accuracy and stacking strength of the baked stacked body 10 obtained by baking and easy separation into the ceramic sheet 1 can be satisfied.

It is also possible to set the proportion of the burning loss material to 20 to 40 wt % in 100 wt % of the separation material 312. When the proportion of the burning loss material is within this range, stacking accuracy and stacking strength of the baked stacked body 10 and easiness of separation into the ceramic sheet 1 can be simultaneously satisfied.

Particularly, when the proportion of the burning loss material is 20 to 30 wt % in 100 wt % of the separation material 312, the baked stacked body 10 can be formed with high dimensional accuracy. When the proportion of the burning loss material is 30 to 40 wt % in 100 wt % of the separation material 312, the strength of the baked stacked body 10 can be controlled to a suitable level and the ceramic plate 1 can be efficiently obtained in the separation step.

### Example 4

This example is intended to explain a method where the punch-out/stacking apparatus for punching out and stacking the sheet pieces 431 is changed, while the method is carried out on the basis of the production method of the ceramic plate of example 1.

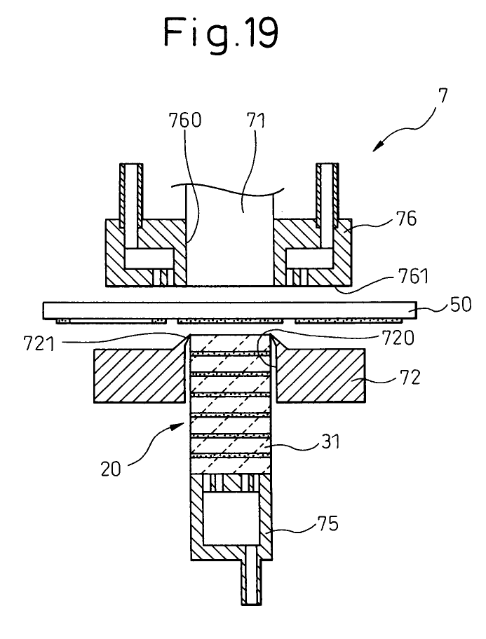

As shown in FIG. 19, the punch-out/stacking apparatus 7 includes a stacking holder having a hollow structure, not shown, a punch 71 causing stroke towards the stacking holder, a die 72 having a hole 720 penetrating through the punch 71 and a holding block 76 having an adsorption surface 761 for adsorbing the green sheet 50 in such a manner as to face the die 72. The punch 71, in particular, of this example is so constituted as to penetrate through a through-hole 760 formed in the holding block 76.

The punch-out/stacking apparatus 7 is so constituted as to punch out the sheet pieces 31 from the green sheet 50 by the combination of the punch 71 and the die 72 and to form the sheet stacked body 20 inside the hole 720 of the die 72. A guide 75 having an adsorption surface at the upper end face is disposed inside the stacking holder in such a manner as to be capable of sliding in the stroke direction of the punch 71. Using the guide 75, the sheet stacked body 20 formed inside the stacking holder can be held while being pressed in the stacking direction.

The die 72 in this example particularly has the hole 720 having an inner diameter that is greater than an outer diameter of the sheet stacked body 20 to be produced. A punch-out blade 721 the diameter of which progressive decreases towards the punch 71 and the open shape of which is substantially coincident with the shape of the punch-out area 310 (see FIG. 1) is formed at the open end portion of the hole 720 on the side of the punch 71.

Therefore, when the sheet pieces 31 are punched out from the green sheet 50 and are stacked, friction does not occur between the outer peripheral surface of the sheet stacked body 20 and the inner peripheral surface of the stacking holder. Therefore, deformation does not occur in the outer peripheral portion of each stacked piece 31 in the intermediate stacked body 30 produced by using the punch-out/stacking apparatus 7 of this example.

Therefore, the intermediate stacked body 30 having high stacking accuracy can be obtained by stacking the sheet pieces 31 having high flatness by using the punch-out/stacking apparatus 7 of this example. The ceramic plate 1 having high flatness and excellent quality can be obtained from the baked stacked body 10 obtained by baking this intermediate stacked body 30.

Other conditions, functions and effects are similar to those of Example 1.

1. A method for producing thin sheet-like ceramic plates by baking a ceramic raw material, comprising:
forming a green sheet from the ceramic raw material;
arranging a separation material comprising a burning loss material capable of being burnt and lost by baking, in a punch-out area for punching out sheet pieces on a surface of said green sheet;
punching out said punch-out area from said green sheet to obtain said sheet pieces;
stacking said punched out sheet pieces to form an intermediate stacked body;
baking said intermediate stacked body to obtain a baked stacked body comprising stacked ceramic layers; and
separating said ceramic layers from said baked stacked body to obtain discrete ceramic plates.

2. A method for producing ceramic plates as defined in claim 1, wherein a plurality of mini-blocks consisting of said separation material are arranged, with gaps formed therebetween, in said punch-out area in said separation material arrangement step.

3. A method for producing ceramic plates as defined in claim 2, wherein said mini-blocks are arranged in a regular pattern.

4. A method for producing ceramic plates as defined in claim 1, wherein said ceramic raw material comprises at least one member selected from the group consisting of PZT, PLZT, BaTiO₃, Al₂O₃, AlN, TiO₂, ZrO₂ and ZnO.

5. A method for producing ceramic plates as defined in claim 1, wherein said separation material is essentially composed of said burning loss material.

6. A method for producing ceramic plates as defined in claim 1, wherein said separation material comprises said burning loss material dispersed in said ceramic raw material.

7. A method for producing ceramic plates as defined in claim 6, wherein 100 wt % of said separation material contains 10 to 50 wt % of said burning loss material.

8. A method for producing ceramic plates as defined in claim 1, wherein said burning loss material comprises at least either one of carbon particles and organic carbide particles.

9. A method for producing ceramic plates as defined in claim 1, wherein ultrasonic vibration is applied to said baked stacked body in said separation step to separate said ceramic layers discretely.

10. A method for producing ceramic plates as defined in claim 1, wherein said ceramic plate has a thickness of 30 to 250 μm and a surface area of 9 to 900 mm².

11. A method for producing ceramic plates as defined in claim 1, wherein said intermediate stacked body is baked in said baking step under the application of a load in a stacking direction.

12. A thin sheet-like ceramic plate produced by baking a ceramic raw material according to the production method of a ceramic plate as defined in any one of claims 1 to 11 claim 1.

13. A ceramic plate as defined in claim 12, which has a thickness of 30 to 250 μm and a surface area of 9 to 900 mm².
